(19) United States
(12) Patent Application Publication
(10) Pub. No.: US 2013/0088317 A1
(43) Pub. Date: Apr. 11, 2013

(54) REACTOR AND METHOD OF MANUFACTURING THE SAME

(71) Applicants: Hideo Tawara, Yokkaichi-City (JP); Hiromi Yabutani, Yokkaichi-City (JP); Takahiro Onizuka, Yokkaichi-City (JP); Akinori Ooishi, Yokkaichi-City (JP)

(72) Inventors: Hideo Tawara, Yokkaichi-City (JP); Hiromi Yabutani, Yokkaichi-City (JP); Takahiro Onizuka, Yokkaichi-City (JP); Akinori Ooishi, Yokkaichi-City (JP)

(73) Assignee: SUMITOMO WIRING SYSTEMS, LTD., Yokkaichi-City (JP)

(21) Appl. No.: 13/466,171

(22) Filed: May 8, 2012

(30) Foreign Application Priority Data
Oct. 11, 2011 (JP) 2011-223698

(51) Int. Cl. H01F 27/26; H01F 7/06

(52) U.S. Cl. 336/212; 29/602.1

(57) ABSTRACT

An annular core (14) of a reactor (10) has two core mold members (24a, 24b) integrated by bonding core segments (32) and gap plates (34) with a cyanoacrylate-based adhesive agent (36) to each other and insert-molding the bonded core segments (32) and gap plates (34) with a thermoplastic resin (38).

### BACKGROUND OF THE INVENTION

1. Field of the Invention

The invention relates to a reactor used for components of power converters, such as DC-DC converters mounted on hybrid vehicles.

2. Description of the Related Art

Hybrid vehicles or electric vehicles that employ an electric motor as a power source in addition to or instead of an engine have become increasingly common in recent years due to a rise in awareness of environment problems. These vehicles include a reactor to raise a voltage from a DC power to a drive voltage for the electric motor.

A reactor has a coil wound around an annular core, as described in JP-A-2008-263062 or JP-A-2010-245457, for example. The reactor includes a switching circuit that takes out a high voltage using a back electromotive force by repeating ON-OFF of an electric distribution to the coil.

The annular core has core segments formed of a magnetic material and non-magnetic gap plates are interposed between the core segments to form gaps in a magnetic path. The inductance of the reactor is defined by a gap distance, and hence the gap distance must be set with high degree of accuracy.

The reactor described in JP-A-2008-263062 or JP-A-2010-245457 has the core segments and the gap plates fixed by bonding with a thermosetting adhesive. The thermosetting adhesive has a high viscosity. Hence, large thick bonding layers are formed between the core segments and the gap plates and can vary the gap distances. As a result, accurate management of the thickness of the bonding layers is difficult and affects the ability to set the inductance with high accuracy. Dimensional errors caused by variations in thickness of the bonding layers also can complicate the assembly of the reactor.

The core segments and the gap plates must be held with an adhesive fitting jig until the thermosetting adhesive is cured. Thermal curing of the adhesive agent in a thermosetting bath takes time. Accordingly, a number of adhesive fixing jigs and thermosetting baths must be prepared to achieve mass production and there is a corresponding increase in the space requirement and cost of the manufacturing facility.

In view of such circumstances, an object of the invention is to provide a reactor having a novel structure that allows magnetic characteristics to be set with higher accuracy and lower cost, and to provide a method of manufacturing reactors.

### SUMMARY OF THE INVENTION

The invention relates to a reactor with an annular core having a plurality of core segments, a gap plate interposed therebetween and a coil wound around the annular core. The annular core includes a core mold member formed integrally by bonding the core segments and the gap plate to each other with a cyanoacrylate-based adhesive agent, and insert-molding the same with a thermoplastic resin.

The core segments and the gap plate of the annular core are bonded together with the cyanoacrylate-based instantaneous adhesive agent. The instantaneous adhesive agent has low viscosity and can enter fine gaps between surfaces of the core segments and a surface of the gap plate. Thus, the core segments and the gap plate can be bonded together without substantially forming the adhesive layer. Accordingly, the thickness of the adhesive layer need not be managed, and a gap distance in the annular core can be set with high degree of accuracy. Consequently, the magnetic characteristics of the reactor can be set with high accuracy. The absence of an adhesive layer between the core segments and the gap plate also improves the dimensional accuracy of the annular core, thereby facilitating assembly and improving positional accuracy.

The instantaneous adhesive agent enables the core segments and the gap plate to be bonded instantaneously in a normal temperature environment. Consequently, the bonding operation can be performed extremely easily and quickly without a thermosetting bath and without the time for thermosetting. Therefore, the manufacturing cost is reduced.

The core segments and the gap plate that are bonded together are insert-molded to integrate the core mold member in a thermoplastic resin. Accordingly, a laminated structure including the core segments and the gap plate can be handled as a unit, so that assembly of the annular core can be performed easily. In addition, the coating of the core segments and the gap plate with the resin ensures rigidity and durability of the core segments and the gap plate. The resin coating also fixes the core segments and the gap plate stably in a laminated state. Thus, the cyanoacrylate-based adhesive of the invention simply provides a provisional fixing force until the insert-molding of the core segments and the gap plate is completed. The adhesive force is no longer necessary after the insert molding.

The annular core preferably has the coil wound around two inner cores and two outer cores couple end portions of the inner cores to each other. Each of the inner cores defines the core mold member.

The core segments and the gap plate that constitute the inner cores may be handled integrally as the core mold member that will be wound by the coil. Accordingly, the insertion of the inner cores into the coils may be performed easily when assembling the reactor. Also, the core segments, the gap plates and the bobbin that insulates the core segments from the coil all may be coated by the resin. Consequently, the number of components is reduced and the assembly operation of the bobbin may be eliminated.

The core mold member may be formed by integrating one of the inner cores with a side bobbin that positions the outer cores with respect to the inner cores. Thus, two identical core mold members are used to form the annular core.

In this embodiment, the side bobbin that positions the outer cores with respect to the inner cores is made integral with the core mold member by the thermoplastic resin that coats the core segments and the gap plate of the inner cores. Accordingly, the number of components is reduced and the efficiency of the assembly operation is improved. Also, the core mold members are identical and only one type of a forming mold is required for insert-molding the core segments and the gap plates. Therefore, the cost of the forming mold is reduced and the management of the components is easier.

One of the inner cores, the side bobbin, and the outer core positioned by the side bobbin may be integrated to form the core mold member. In this configuration, the inner and outer cores are integrated as the core mold member. Accordingly, the annular core can be formed by only the two core mold members, thereby further reducing the number of components and improving efficiency of the assembly operation. Also, the inner and outer cores are coated with the resin to achieve a stable fixing force between the inner and outer cores.

One of the outer cores and the two inner cores may be integrated to form the core mold member. The core mold member and the other outer core then form the annular core. In this configuration, the core mold member has a U-shape including the two inner cores coupled to one of the outer cores. Accordingly, the coil can be inserted into the pair of inner cores at once to further improve the assembly.

The invention also relates to a method of manufacturing a reactor including an annular core having core segments and a gap plate interposed therebetween, and a coil wound around the annular core. The method includes forming a core mold member integrated by bonding the core segments and the gap plate to each other with a cyanoacrylate-based adhesive agent and insert-molding with the thermoplastic resin. The method then includes using the core mold member to form the annular core.

The method of manufacturing the reactor uses a cyanoacrylate-based instantaneous adhesive agent to fix the core segments and the gap plate in a laminated state without forming bonding layers. Accordingly, there is no need to manage the thickness of the adhesive layer and the gap distance in the annular core can be set with high accuracy. Consequently, the magnetic characteristics of the reactor can be set with high accuracy. Also, the dimensional accuracy of the annular core is improved, thereby facilitating assembly and the positional accuracy of the respective members, such as the coil, are improved.

The instantaneous adhesive enables the core segments and the gap plate to be bonded quickly under a normal temperature environment. Accordingly, the bonding can be performed extremely easily and quickly without a thermosetting bath or a long time for thermosetting as in the case of a thermosetting adhesive. Therefore, the manufacturing cost of the reactor is reduced. Also, insert-molding the core segments and the gap plate with the thermoplastic resin ensure a strong fixing force between the core segments and the gap plate. Therefore, the bonding operation with the cyanoacrylate-based adhesive agent simply provides a provisional fixing force until the insert-molding of the core segments and the gap plate is completed, and the adhesive force is not needed after the insert molding.

Forming the core molding member by insert-molding the core segments and the gap plate with the thermoplastic resin enables the core segments and the gap plate to be handled in the laminated state as an integrated product. Accordingly, assembly of the annular core can be performed easily.

The invention enables the core segments and the gap plate to be fixed in the laminated state without the intermediary of the bonding layer. Accordingly, the gap distances in the annular core can be set with higher accuracy, so that the magnetic characteristics of the reactor can be set with higher accuracy. Also, the thermosetting bath and the thermosetting process are not necessary so the reactor can be manufactured at a lower cost.

### BRIEF DESCRIPTION OF THE DRAWINGS

FIG. 1 is a top view of a reactor of a first embodiment of the invention.

FIG. 2 is a cross-sectional view taken along the line II-II in FIG. 1.

FIG. 3 is an exploded perspective view of the reactor shown in FIG. 1.

FIG. 4 is an explanatory enlarged cross-sectional view showing a bonded state of core segments and gap plates.

FIG. 5 is a top view of a core mold member shown in FIG. 1.

FIG. 6 is top view of a reactor of a second embodiment of the invention.

FIG. 7 is a cross-sectional view taken along the line VII-VII in FIG. 6.

FIG. 8 is an exploded perspective view of the reactor shown in FIG. 6.

FIG. 9 is a top view of a reactor of a third embodiment of the invention.

FIG. 10 is a cross-sectional view taken along the line X-X in FIG. 9.

FIG. 11 is an exploded perspective view of the reactor shown in FIG. 9.

FIG. 12 is an exploded top view of the reactor of a fourth embodiment.

### DETAILED DESCRIPTION OF THE DRAWINGS

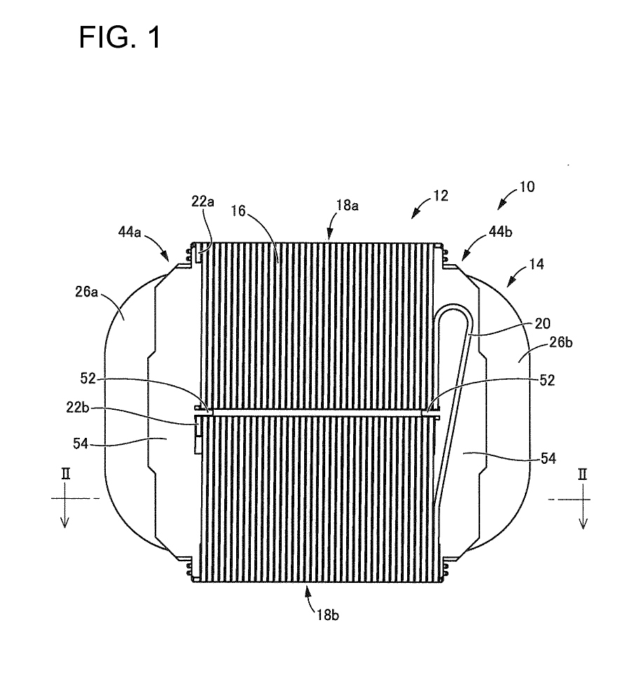

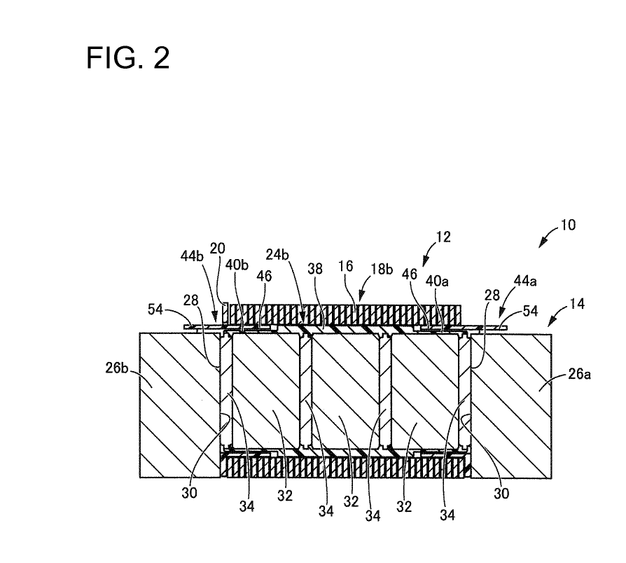

FIGS. 1 to 3 show a reactor 10 of a first embodiment of the invention. The reactor 10 includes a coil 12 and an annular core 14 on which the coil 12 is wound. In the following description, the side of installation when the reactor 10 is installed (the lower side in FIG. 2) is defined as the bottom, and the opposite side is defined as the top.

The coil 12 includes a pair of coil elements 18a, 18b formed by winding a line of winding wire 16 continuing without any bonded portion in a helical shape and a coil coupling 20 that couples the coil elements 18a, 18b. The coil elements 18a, 18b have the same number of turns and have a substantially rectangular shape when viewed in the axial direction. The coil elements 18a, 18b are arranged side-by-side so that their axes are parallel, and part of the winding wire 16 on one end of the coil 12 is bent into a U-shape to form the coil coupling 20. In this configuration, the directions of winding of the coil elements 18a, 18b are the same.

The winding wire 16 has an insulative coating formed on the outer periphery of an electrically conductive member formed, for example, from copper or aluminum. The winding wire 16 used here has a rectangular copper conductive member and an insulative coating formed from enamel, such as polyamide-imide. The thickness of the insulative coating is preferably from 20 μm to 100 μm inclusive, and the larger the thickness, the more pinhole can be reduced, so that the electric insulative properties can be enhanced. The coil elements 18a, 18b have a hollow rectangular tubular shape by winding the coated rectangular wire edgewise. Examples of the winding wire 16 that can be used here include those having various cross-sectional shapes, such as circular, oval and polygonal in addition to the above-described rectangular shape. The rectangular wire is capable of forming a coil having a higher space factor than the case where a round wire having a circular cross section is used. The coil elements are manufactured by the separate winding wires and joining end of the winding wires 16 of the respective coil elements are joined by welding or the like to form an integral coil.

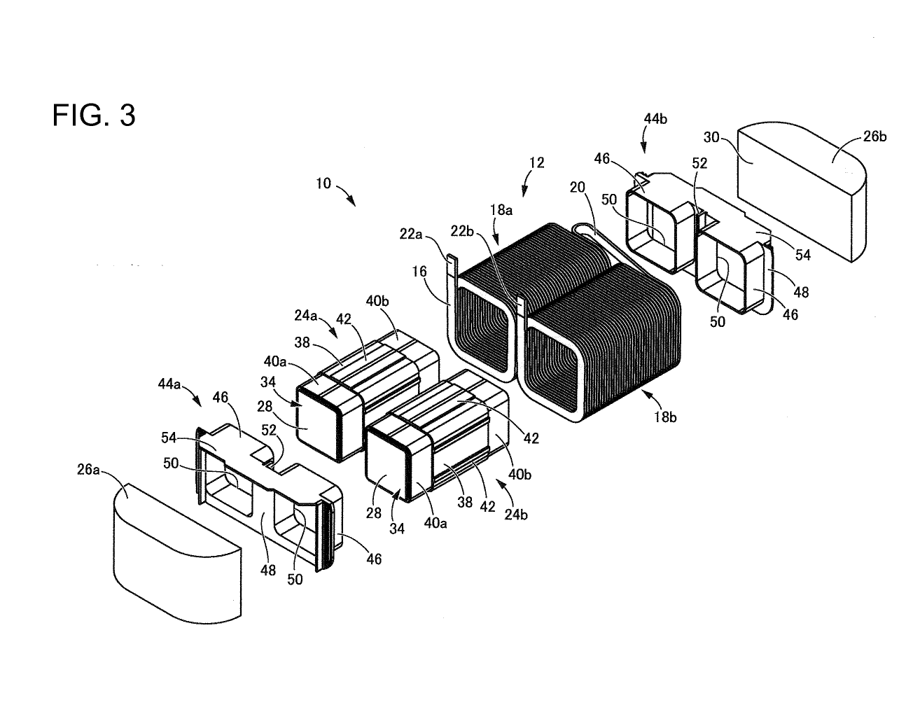

Both end portions 22a, 22b of the winding wire 16 of the coil 12 are expanded and drawn up from a turn formed portion at one end of the coil 12 (near side in FIG. 3). Terminal fixtures, not shown, formed of a conductive material are connected to conductive portions of the end portions 22a, 22b of the drawn winding wire 16 exposed by peeling off the insulative coating. The terminal fixtures connect the coil 12 to an external device, not shown, such as a power source that supplies power to the coil 12.

The annular core 14 includes two inner cores 24a, 24b formed by winding the respective coil elements 18a, 18b, and two outer cores 26a, 26b having no coil 12 wound thereon and exposed from the coil 12. The inner cores 24a, 24b have substantially parallelepiped shapes and the outer cores 26a, 26b are prismatic members with trapezoidal shapes having curved oblique lines. The inner cores 24a, 24b are in substantially parallel spaced relationship and are between the outer cores 26a, 26b so that end surfaces 28, 28 of the inner cores 24a, 24b contact inner end surfaces 30, 30 of the outer cores 26a, 26b. Thus, the outer cores 26a, 26b couple the inner cores 24a, 24b to form an annular shape. The inner cores 24a, 24b and the outer cores 26a, 26b of the annular core 14 form a closed magnetic path when the coil 12 is excited.

The inner cores 24a, 24b and the outer cores 26a, 26b are formed of the same material and will be referred to generically herein as the inner cores 24 and the outer cores 26 as long as distinction is not necessary. As shown in FIG. 2, the inner core 24 is a laminated body formed by laminating strip-shaped core segments 32 alternately with gap plates 34. The core segments 32 are formed of a magnetic material and have a substantially parallelepiped shape. The gap plates 34 are formed of a non-magnetic material. In contrast, the outer core 26 is a core strip formed of the magnetic material. Examples of the respective core strips that can be used include a compact using magnetic powder and a laminated body having a plurality of thin magnetic plates (for example, electromagnetic steel plates) having an insulative coating.

The compact may be formed from iron family metals such as Fe, Co, Ni, Fe group alloys, such as Fe—Si, Fe—Ni, Fe—Al, Fe—Co, Fe—Cr, Fe—Si—Al, a compressed powder compact using powder formed of soft magnetic material such as a rare earth metal or an amorphous magnetic material, a sintered body formed by pressing and then sintering the above-described powder, and a mold hardened member obtained by injection-molding or cast-molding or the like a mixture of the above-described powder and a resin. Examples of the core strip include ferrite core, which is a sintered body of a metallic oxide. The compact enables various solid-shaped magnetic cores to be formed easily.

The compressed powder compact preferably may be powder formed of the soft magnetic material having an insulative coating on the surface thereof and, in this case, may be obtained by shaping and sintering the powder at a temperature not higher than a heat-proof temperature of the above-described insulative coating. Typical examples of the insulative coating include those formed of a silicone resin or phosphate.

The outer core 26 and the core segments 32 of the inner core 24 may be made of different materials. For example, the core segments 32 of the inner core 24 may be the compressed powder compact or the laminated body described above, and the outer core 26 may be the compact hardened body. In this case, the saturated magnetic flux density of the inner core 24 easily can be higher than that of the outer core 26. Here, the core segments 32 and the outer core 26 are a compressed powder compact formed of iron or soft magnetic powder containing iron such as iron or steel.

The gap plates 34 are substantially the same size as the core segments 32 when viewed in the direction of lamination and are arranged in gaps provided between the core segments 32 for adjusting the inductance. The gap segments are formed of material having a lower permeability than the above-described core segments 32, and typically non-magnetic materials such as alumina, a glass epoxy resin, or unsaturated polyester.

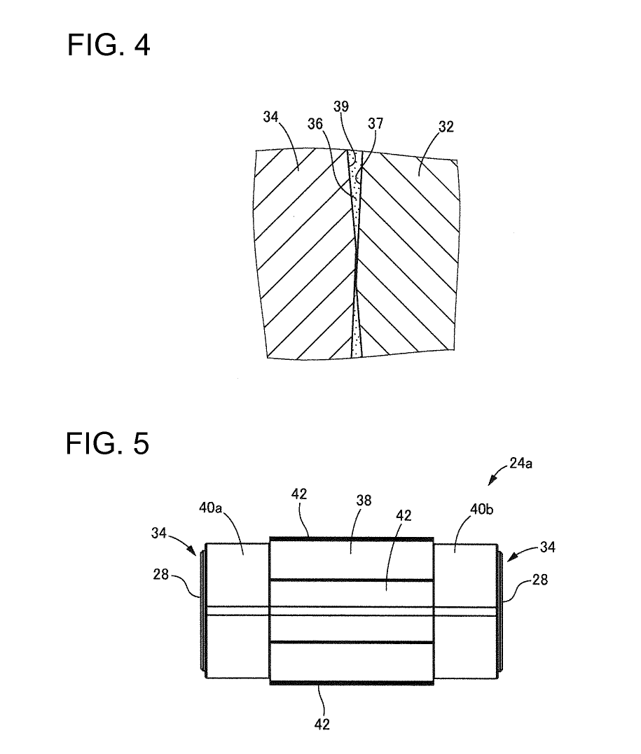

A plurality of the core segments 32 and a plurality of the gap plates 34 are laminated alternately in the inner core 24 so that the gap plates 34 are interposed between the core segments 32, 32. As shown in FIG. 4, the core segments 32 and the gap plates 34 are bonded together with an adhesive agent 36. The adhesive agent 36 is a cyanoacrylate-based adhesive used as an instantaneous adhesive agent. The adhesive agent 36 enters minute gaps between a surface 37 of the core segment 32 and a surface 39 of the gap plate 34 to bond the core segment 32 and the gap plate 34 together.

As shown in FIG. 2, the laminated core segments 32 and the gap plates 34 are coated with thermoplastic resin 38 by insert molding so that the thermoplastic resin 38 extends in substantially the entire length in the direction of lamination (the lateral direction in FIG. 2), and over the entire periphery thereof. Accordingly, the thermoplastic resin 38 fixedly integrates the core segments 32 and the gap plates 34 to form the inner cores 24a, 24b as core mold members. As shown in FIG. 5, the gap plates 34, 34 are disposed at both ends 40a, 40b of the inner core 24, and project slightly out from the thermoplastic resin 38. The end portions 40a, 40b of the inner core 24 are slightly thinner for insertion and positioning into tubular portions 46, 46 of side bobbins 44a, 44b. Projecting ridges 42 are formed on an outer peripheral surface of the thermoplastic resin 38 and extend in the longitudinal direction (the lateral direction in FIG. 5) of the inner core 24 to reduce the contact surface with respect to the coil 12 to achieve easy insertion.

The thermoplastic resin 38 that may be used include insulative materials, such as polyphenylene sulfide (PPS) resin, polytetrafluoroethylene (PTFE) resin, or liquid crystal polymer (LDP).

The number of the core segments 32 and the gap plates 34 may be selected as needed to achieve a desired inductance of the reactor 10. Also, the shapes of the core segments 32, the outer core 26, and the gap plates 34 may be selected as needed. In addition, as is clear from FIG. 2, the outer cores 26a, 26b project down from the inner cores 24a, 24b in the annular core 14. Accordingly, a lower surface of the coil 12 and lower surfaces of the outer cores 26a, 26b are substantially flush with each other.

The side bobbins 44a, 44b are provided respectively between the inner cores 24a, 24b and the outer cores 26a, 26b to position the outer core 26 with respect to the inner core 24, and enhance the insulating properties between the coil 12 and the annular core 14. The side bobbins 44a, 44b are identical. Each side bobbin 44 has two tubular portions 46, 46 to be fit on either one of the end portions 40a, 40b and the outer peripheries of the inner cores 24a, 24b. A frame 48 is formed integrally with each side bobbin 44 and comes into abutment with an end surface of the coil 12.

The frame 48 has a flat-panel shape and includes two openings 50, 50 that allow insertion of the respective inner cores 24a, 24b. The tubular portions 46, 46 project from the openings 50, 50. A partitioning wall 52 is formed between the tubular portions 46, 46 of the frame 48 and is inserted between the coil elements 18a, 18b to hold the coil elements 18a, 18b in a non-contact manner. Furthermore, a flange 54 is formed on an upper end surface of the frame 48 to allow placement of the coil coupling 20. The flange 54 is configured to insulate between the coil coupling 20 and the outer core 26. The frame 48 may be formed from the same insulative material as the thermoplastic resin 38 of the inner cores 24a, 24b.

The reactor 10 may be manufactured according to the following method. First, two of the inner cores 24 as core mold members are formed. More specifically, predetermined numbers of the core segments 32 and the gap plates 34 are laminated alternately, and the adhesive 36, such as the cyanoacrylate-based instantaneous adhesive, is perfused between the contact surfaces of the core segments 32 and the gap plates 34 to bond the core segments 32 and the gap plates 34 in the laminated state. A suitable jig may be used when laminating the core segments 32 and the gap plates 34.

The laminated body of the core segments 32 and the gap plates 34 fixed by the adhesive agent 36 then is set in a forming die as an insert and a thermoplastic resin material is filled and cured therein. Accordingly, the core segments 32 and the gap plates 34 are integrated by the thermoplastic resin 38 to form the inner core 24 as the core mold member. These operations are carried out for each of the two inner cores 24a, 24b.

The inner cores 24a, 24b then are inserted into the respective coil elements 18a, 18b. Subsequently, the tubular portions 46, 46 of the side bobbins 44a, 44b are fit on the end portions 40a, 40b of the respective inner cores 24a, 24b, and the tubular portions 46, 46 are inserted into the coil elements 18a, 18b. The outer cores 26a, 26b then are arranged on the side bobbins 44a, 44b by bonding or fitting to form the annular core 14 with the coil 12 wound thereabout to complete the reactor 10. The end surface 28 of the inner core 24 is exposed from the opening 50 of the frame 48 and contacts the inner end surface 30 of the outer core 26. It is also applicable to insert the inner cores 24a, 24b assembled with one of the side bobbins 44a, 44b into the coil elements 18a, 18b.

The core segments 32 and the gap plates 34 that constitute the annular core 14 of the reactor are fixed into the laminated state with the adhesive agent 36, such as the cyanoacrylate-based instantaneous adhesive agent. Accordingly, the core segments 32 and the gap plates 34 can be laminated substantially without bonding layers therebetween. Consequently, there is no need to manage the thickness of the adhesive agent and the gap distances in the annular core 14 can be set with high accuracy, so that the magnetic characteristics of the reactor 10 can be set with high accuracy. Additionally, the instantaneous adhesive agent 36 enables the core segments 32 and the gap plates 34 to be bonded instantaneously at normal temperature. Accordingly, the bonding operation can be performed quickly in a simple facility without a thermosetting bath and in a short time. Therefore, the manufacturing cost of the reactor 10 is reduced.

The core segments 32 and the gap plates 34 that have been laminated with the adhesive agent 36 are insert molded with the thermoplastic resin 38 to form the inner core 24 as a core mold member is formed. Accordingly, the core segments 32 and the gap plates 34 are fixed with the thermoplastic resin 38, and the laminated state can be held stably. In addition, the core segments 32 and the gap plates 34 can be handled integrally to increase efficiency of the assembly operation of the reactor 10.

The inner cores 24a, 24b of the annular core 14 are configured identically. Accordingly, the inner cores 24a, 24b may be molded with the same forming die, and hence the cost for the forming die may be reduced. Also, the bobbins that cover the core segments 32 and the gap plates 34 may be configured with the thermoplastic resin 38 to reduce the number of components and the number of assembly steps.

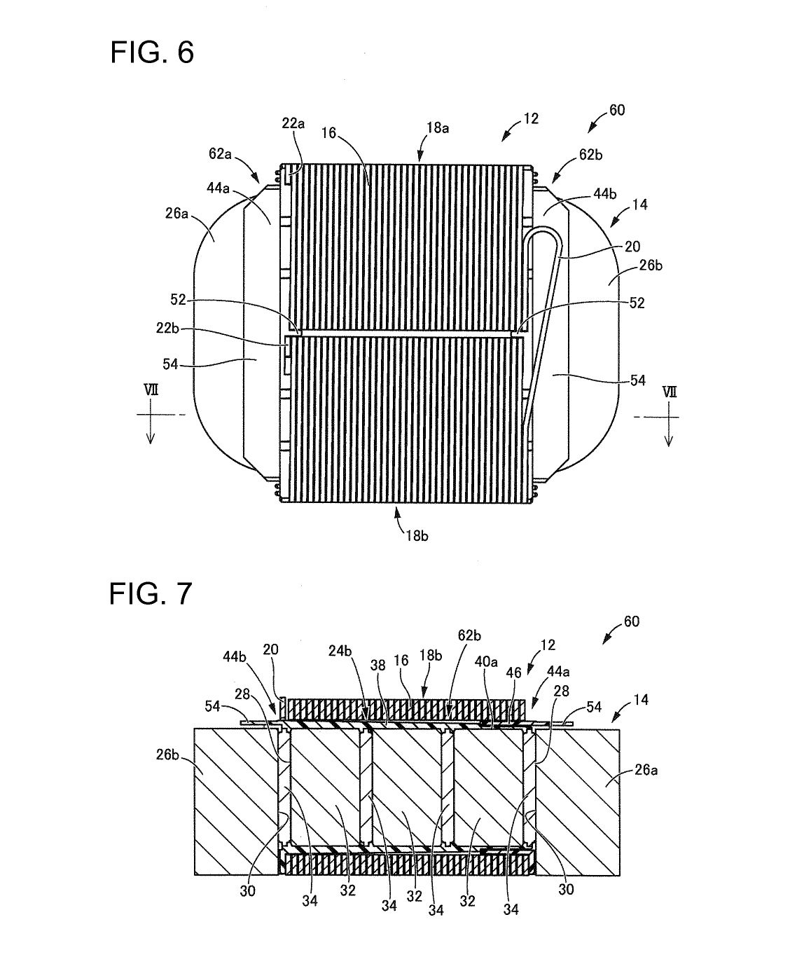

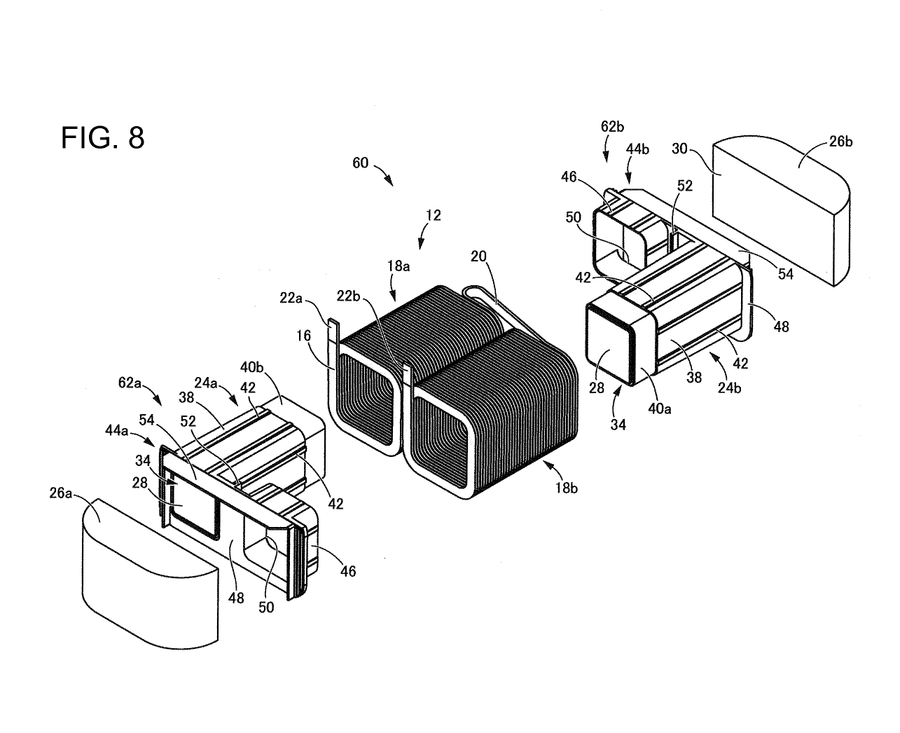

FIGS. 6 to 8 show a reactor 60 of a second embodiment of the invention. In the following description, members and parts having the same configurations as those in the first embodiment are designated by the same reference numerals as the first embodiment in the drawing, and the description thereof is omitted as needed.

The reactor 60 in this embodiment includes core mold members 62a, 62b formed by one of the side bobbins 44a, 44b integrally formed on the respective inner cores 24a, 24b. Accordingly, one of the inner cores 24a is coupled integrally to the side bobbin 44a, and the other inner core 24b is coupled integrally to the side bobbin 44a. The core mold members 62a, 62b may be identical. The core mold members 62a, 62b as described above may be molded by providing a molding cavity corresponding to a side bobbin 44 on a forming die used for the insert-molding of the laminated body of the core segments 32 and the gap plates 34 bonded with the adhesive agent 36 and integrally forming the side bobbin 44 with the thermoplastic resin 38 for coating the laminated body of the core segments 32 and the gap plates 34 when insert molding the laminated body. The inner core 24a of one core mold member 62a then is inserted into the coil element 18a on one side, while the inner core 24b of the other core mold member 62b is inserted into the other coil element 18b. Both inner cores 24a, 24b are fit into the tubular portions 46, 46 of the side bobbins 44b, 44a on the other side, and the outer cores 26a, 26b are assembled to the side bobbins 44a, 44b respectively to form the annular core 14.

The side bobbin 44 of the reactor 60 is formed integrally with the inner core 24 in each of the core mold members 62a, 62b to reduce the number of components and to improve the efficiency of the assembly work. Also, the core mold members 62a, 62b are identical and may be manufactured at low cost from the single forming die.

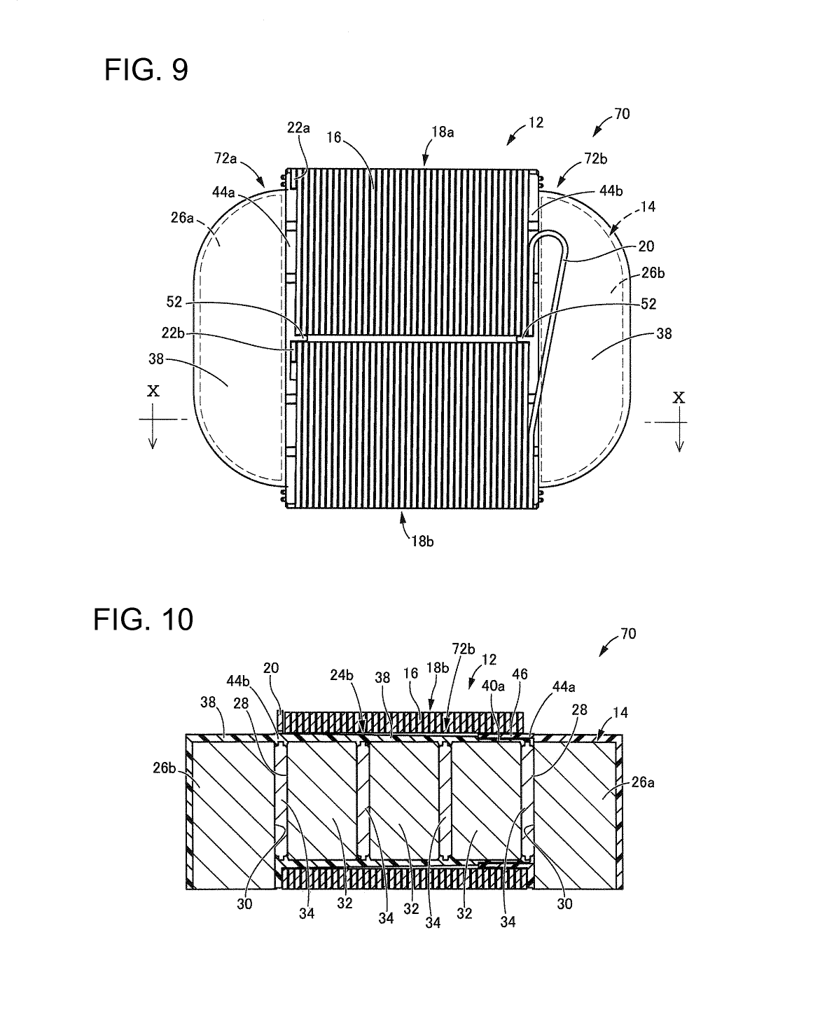

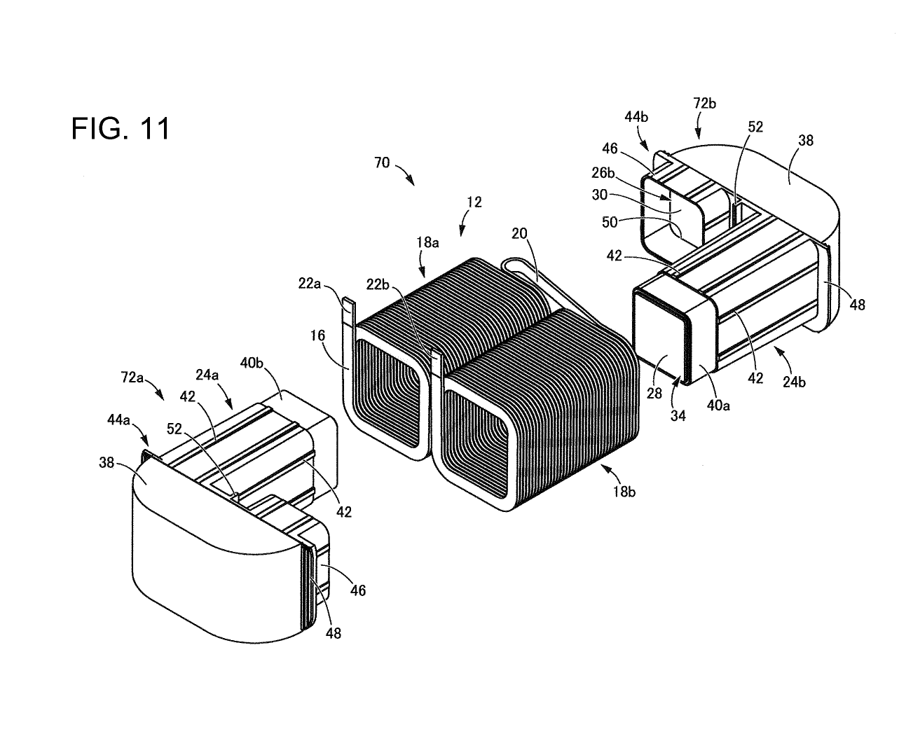

FIGS. 9 to 11 show a reactor 70 of a third embodiment. The reactor 70 includes core mold members 72a, 72b formed by one of the outer cores 26a, 26b integrally formed on the respective inner cores 24a, 24b to be assembled to the side bobbins 44a or 44b in addition to the one of the side bobbins 44a, 44b. Accordingly, the outer core 26 also is coated with the thermoplastic resin 38 and is coupled integrally with the laminated body of the core segments 32 and the gap plates 34. Consequently, the core mold members 72a, 72b may be identical. The core mold members 72a, 72b may be formed by providing the molding cavity corresponding to the side bobbin 44 on the forming die, setting the laminated body of the core segments 32 and the gap plates 34 bonded with the adhesive agent 36 together with the outer core 26 into the forming die, and insert-molding the same with the thermoplastic resin 38. The inner core 24a of one of the core mold members 72a then is inserted into the one of the coil elements 18a, while the inner core 24b of the other core mold member 72b is inserted into the other coil element 18b, and the inner cores 24a, 24b are fit into the tubular portions 46, 46 of the side bobbins 44b, 44a on the other side to form the annular core 14.

The outer core 26, the inner core 24 and the side bobbin 44 are molded integrally in the core mold members 72a, 72b of the reactor 70. Accordingly, the annular core 14 can be formed by only the core mold members 72a, 72b for further reducing the number of components and improving efficiency of the assembly operation. Also, the inner core 24 and the outer core 26 are coated with the thermoplastic resin 38 and fixed stably together.

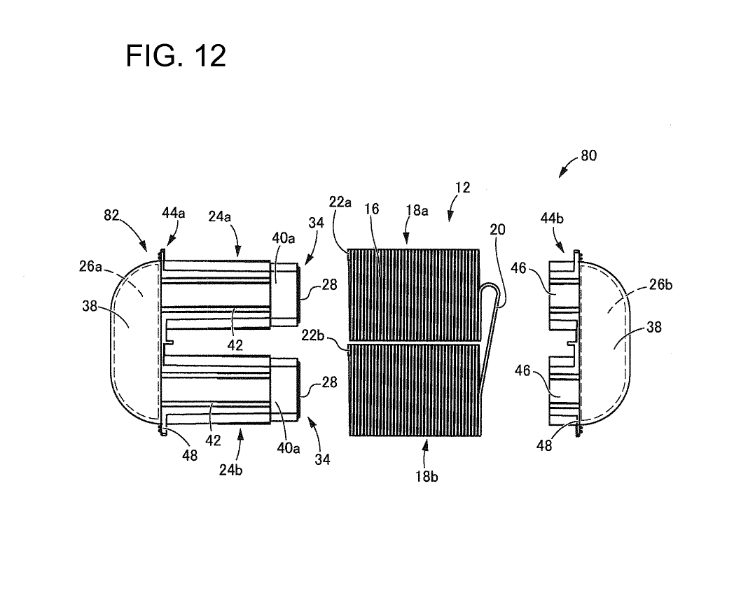

FIG. 12 shows a reactor 80 of a fourth embodiment of the invention. The reactor 80 includes a core mold member 82 formed by the two inner cores 24a, 24b and the side bobbin 44a integrally formed on the outer core 26a. Accordingly, the core mold member 82 has a U-shape with the two inner cores 24a, 24b projecting from the outer core 26a. The core mold member 82 may be formed by providing the molding cavity corresponding to the side bobbin 44a on the forming die. The laminated core segments 32 and gap plates 34 that have been bonded with the adhesive agent 36 then are placed with the outer core 26a into the forming die, and are insert-molding with the thermoplastic resin 38. The outer core 26b is formed integrally formed with the side bobbin 44b by the insert molding. The inner cores 24a, 24b of the core mold member 82 then are inserted into the coil elements 18a, 18b respectively and the cylindrical portions 46, 46 of the side bobbin 44b are inserted respectively therein, to form the annular core 14 from the core mold member 82 and the outer core 26b.

The inner cores 24a, 24b are integral with the core mold member 82 of the reactor 80. Therefore, the inner cores 24a, 24b can be inserted into the coil elements 18a, 18b simultaneously, so that the assembly operation has higher efficiency.

The invention is not limited by the detailed description. For example, the detailed shape of the surface of the core mold member may be modified, and the projecting ridges 42 may be omitted. The core segments and the gap plates need not be rectangular, and circular or polygonal shapes may be employed. Various shapes may be employed as the cross-sectional shape of the core mold member corresponding to the shapes of the core segments and the gap plates.

Also, in the fourth embodiment (see FIG. 12), the integral product of the inner cores 24a, 24b and the side bobbin 44a or the side bobbin 44b may be molded in advance, and the outer cores 26a, 26b may be attached separately. Accordingly, advantages achieved by inserting the pair of inner cores 24a, 24b into the coil elements 18a, 18b simultaneously may be enjoyed while securing the ease of molding.

What is claimed is:

1. A reactor (10; 60; 70; 80) comprising an annular core (14) having a plurality of core segments (32) and at least one gap plate (34) interposed between the core segments (32), and a coil (12) wound around the annular core (14), wherein
the annular core (14) includes at least one core mold member formed integrally by bonding the core segments (32) and the gap plate (34) to each other with a cyanoacrylate-based adhesive agent (36), and insert-molding the core segments (32) and the gap plate (34) with a thermoplastic resin (38) to define a unitary matrix of the thermoplastic resin (38) surrounding parts of the core segments (32) and the gap plate (34).

2. The reactor of claim 1, wherein the at least one core mold member comprises two core mold members defining inner cores (24a, 24b) having the coil (12) wound thereon, the annular core (14) further comprises two outer cores (26a, 26b) coupling ends of the inner cores (24a, 24b) to each other.

3. The reactor of claim 2, wherein the core mold members are substantially identical and each further comprises a side bobbin (44a, 44b) integrated with one of the inner cores (24a, 24b), the side bobbins (44a, 44b) being configured to position the outer cores (26a, 26b) with respect to the inner cores (24a, 24b).

4. The reactor of claim 3, wherein each of the core mold members further comprises one of the outer cores (26a, 26b) integrated with one of the inner cores (24a, 24b) and one of the side bobbin (44a, 44b).

5. The reactor of claim 4, wherein the core mold members are identical.

6. The reactor of claim 1, wherein the at least one gap plate (34) comprises a plurality of gap plates (34).

7. The reactor of claim 1, wherein the core mold member comprises two inner cores (24a, 24b) each having the core segments (32) and the gap plate (34) and having the coil (12) wound thereon, the core mold member further having a first outer core (26a) coupling first ends of the inner cores (24a, 24b) and the annular core (14) further comprising a second outer core (26b) coupling second ends of the inner cores (24a, 24b).

8. A method of manufacturing a reactor (10, 60, 70, 80) including an annular core (14), the method comprising:
bonding core segments (32) and at least one gap plate (34) in an alternating laminated array using a cyanoacrylate-based adhesive agent (36);
molding a thermoplastic resin (38) around at least parts of the laminated array of the core segments (32) and at least one gap plate (34) to form at least one core molding member;
inserting at least part of the core molding member into a coil (12); and
assembling the core molding member with at least one other core (24a, 24b, 26a, 26b) to form the annular core (14).

9. The method of claim 8, wherein the step of molding the thermoplastic resin (38) comprises molding at least one side bobbin (44a, 44b) that is configured to mate with at least one outer core (26a, 26b).

10. The method of claim 8, wherein the step of molding the thermoplastic resin (38) comprises molding the thermoplastic resin (38) at least partly around an outer core (26a, 26b).
